(19) United States
(12) Patent Application Publication
(10) Pub. No.: US 2022/0222681 A1
(43) Pub. Date: Jul. 14, 2022

(54) System and Method for Authentication (Verifying Chain of Custody and Provenance) of Precious Metals and Physical Commodities using Blockchain

(71) Applicant: BASHIR ANASTAS, OAKLAND, CA (US)

(72) Inventor: BASHIR ANASTAS, OAKLAND, CA (US)

(21) Appl. No.: 17/149,690

(22) Filed: Jan. 14, 2021

(51) Int. Cl. G06Q 30/00; G06Q 20/38; H04L 9/30; H04L 9/14; H04L 9/32

(52) U.S. Cl. CPC G06Q 30/018; G06Q 20/389; G06Q 20/3829; G06Q 40/04; H04L 9/14; H04L 9/3239; G06Q 2220/00; H04L 9/3073

(57) ABSTRACT

Chain of custody for physical objects is hard to establish especially for frequently tradeable commodities. This patent is for a process to establish chain of custody, authenticate commodities (such as gold bars) and trace the commodity to its origin. References to gold bars herein apply equally to any commodity, and references to the Bitcoin network apply equally to any distributed ledger or blockchain.

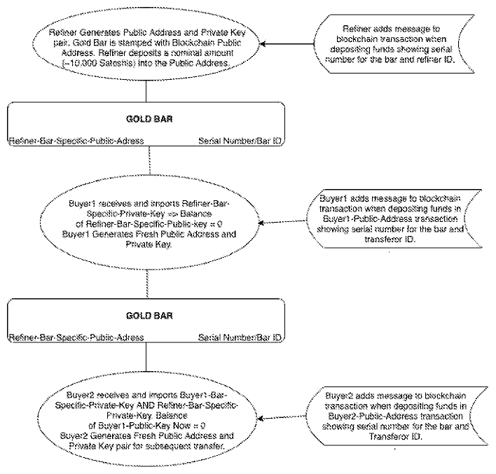

In this method, gold bars are stamped with a unique Bitcoin address at the production stage by the refiners. The address is loaded with a nominal value (say 10,000 Satoshis). At the first sale, the private key to the bar address is provided to the 1^{st} Buyer with the sale. The 1^{st} Buyer then imports the private key.

At the time of a subsequent sale, the 1^{st} Buyer then loads a nominal value into a new Bitcoin address with a message on the blockchain that contains the private key for the address on the bar. 1^{st} Buyer then provides the private key to the new address to the 2^{nd} Buyer.

The process is repeated with subsequent Buyers whereby new addresses are provided with each sale validated by previous private keys transmitted in prior public address on the blockchain.

Forgers and counterfeiters will find it impossible to transfer a forged bar with a public key absent a corresponding private key.

### BACKGROUND

A forgery crisis is quietly roiling the world's gold industry. Gold refining and banking executives tell Reuters that gold bars fraudulently stamped with the logos of major refineries are being inserted into the global market to launder smuggled or illegal gold. The fakes are hard to detect, making them an ideal fund-runner for narcotics dealers or warlords.

Between 2016 and 2019, bars worth at least $50 million stamped with Swiss refinery logos, but not actually produced by those facilities, have been identified by all four of Switzerland's leading gold refiners and found in the vaults of JP Morgan Chase & Co., one of the major banks at the heart of the market in bullion, said senior executives at gold refineries, banks and other industry sources. (https://reut.rs/34VqSJW)

This invention is for a process to help authenticate gold bars in the market place using blockchain technology. This process can be implemented with any secure distributed ledger technology. For the purposes of this filing, the Bitcoin Network is used to describe the process.

### BLOCKCHAIN CRYPTOGRAPHY

Asymmetric cryptography or public cryptography, is an advanced cryptographic technique that ensures that blockchain transactions are legitimate and secure. The system that relies on a pair of keys, a private key which is kept secret and a public key which is broadcasted out to the network. This system helps ensure the authenticity and integrity of a message by relying on advanced cryptographic techniques. The public key is then used with a hash function to create the public address that Bitcoin users use to send and receive funds. The private key is kept secret and is used to sign a digital transaction to make sure the origin of the transaction is legitimate.

On distributed blockchains like Bitcoin, the fundamental pieces of information are the address, associated with a balance and used for sending and receiving funds, and the address' corresponding public and private keys. The generation of an address begins with the generation of a private key. The corresponding public key is derived using a known algorithm. The address, which is used in transactions, is a shorter, representative form of the public key derived by hashing the public key.

The private key is what grants a cryptocurrency user ownership of the funds on a given address. The security of this system comes from the one-way street that is getting from the private key to the public address. It is virtually impossible to derive the private key from the public key.

The above brief description of how blockchain cryptography works is more extensively available in the public domain. It is included in here to articulate the basis of the new invention which relies on a well-established, long-tested and secure cryptographic technology.

### A NEW SYSTEM USING BLOCKCHAIN

This patent uses the security of distributed ledger technology and the public-private key system to (a) Securely transfer ownership of a physical commodity, such as a gold bar, by assigning a unique pair of public-private cryptographic keys to the commodity subject of transfer or sale and stamped with that particular public key; (b) Permanently record the transfer on a distributed ledger by transcribing the transferor's private key in the message field of the transaction on the blockchain; and (c) Require a new public-private key set to be generated to consummate each and every subsequent transfer.

### NEW METHOD IN PRACTICE

Because the individual elements of the claimed method are well established and recognized by those familiar with the technology, the new method is best illustrated by an example. The example uses the Bitcoin blockchain and gold refiners as illustrative use case.

The elements of the new method are:
(a) Generation of a public-private key pair to be initially assigned to the gold bar. More information and examples can be found at https://en.bitcoin.it/wiki/Technical backgroung of verion 1 Bitcoin addresses—or by referring to this open Source JavaScript Client-Side Bitcoin Wallet Generator https://www.bitadress.org/—or this open source generator https://sourceforge,net/projects/bitaddressgen/(many, many other examples readily available with an internet search)
(b) Loading the public address associated with the public key generated in (a) with a nominal balance of crypto currency (e.g. 10,000 Satoshis¹) and including a message that identifies the serial number of the gold bar and the manufacturer or refiner. ¹ Bitcoins are transferred via transactions that specify inputs and outputs. Each transaction has at least one input and one output. Each input spends units of Bitcoin—in this case 10 k Satoshis—to an output that then becomes an Unspent Transaction Output until a later transaction spends it.
(c) The buyer/transferee of the gold bar in (b) receives the private key generated in (a) with the sale.
(d) The buyer/transferee imports the private key and zero out the balance² of the public address in (b) By zeroing out the balance, the buyer/transferee confirms their possession of the private key and demonstrates the provenance of the bar subject of the transaction.
(e) Upon a subsequent transfer or sale, the buyer/transferee repeats the steps in (a) to (d) above.

Attached is a diagram that describes the process.

Provenance and chain of custody in the above-described method is established via the series of transactions recorded on the blockchain, since the transactions identify both the commodity (in the example the gold bar ID) and the transferor.

The exemplary embodiments of the above described method may be embodied as a program containing lines of code that queries the blockchain for a history of transactions beginning with the originator's (e.g. gold refiner) transaction and/or search the blockchain for instances where the commodity unique ID occurs in messages of transactions.

The exemplary embodiments provide a device, system, and method to transfer commodities using blockchain. The invention allows participating entities to transfer ownership of a commodity while establishing a high degree of confidence in the both the provenance and chain of custody of the commodity.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described as acting in certain combinations and even initially claimed as such, one or more features from a claimed combination can in some cases be excised from the combination, and the claimed combination may be directed to a sub-combination or variation of a sub-combination.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. .section. 1.72(b) and is submitted with the understanding that it will not be used to interpret or limit the scope or meaning of the claims. In addition, in the foregoing detailed description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

Those skilled in the art will understand that the above-described exemplary embodiments may be implemented in any suitable software or hardware configuration or combination thereof. An exemplary hardware platform for implementing the exemplary embodiments may include, for example, a Windows platform, a Mac platform, a mobile device having an operating system such as iOS, Android, etc.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed is:

1. A computer implemented method using a blockchain to securely transfer ownership of a physical commodity and establishing chain of custody, by assigning a unique pair of public-private cryptographic keys to the commodity subject of transfer or sale; transmitting the private key with the commodity upon transfer or sale; and permanently recording all transfers and sales on a specific distributed ledger (blockchain) for later verification.
